(19) United States
(12) Patent Application Publication
(10) Pub. No.: US 2014/0257919 A1
(43) Pub. Date: Sep. 11, 2014

(54) REWARD POPULATION GROUPING

(71) Applicant: HEWLETT-PACKARD DEVELOPMENT COMPANY, L.P., Houston, TX (US)

(72) Inventors: George H. Forman, Port Orchard, WA (US); Mark D. Lillibridge, Mountain View, CA (US)

(73) Assignee: Hewlett- Packard Development Company, L.P., Houston, TX (US)

(21) Appl. No.: 13/791,911

(22) Filed: Mar. 9, 2013

(51) Int. Cl. G06Q 30/02

(52) U.S. Cl. CPC G06Q 30/0201
USPC 705/7.29

(57) ABSTRACT

An apparatus and method convert user behavior data into rewards. The method and apparatus determine an undiluted reward for a user of a population of users. The method and apparatus divide the population of users into groups. The apparatus and method determine a dilution factor for each of the groups and assign and/or transmit a reward to the user based upon the undiluted reward and the dilution factor for the group to which that user belongs.

### BACKGROUND

Ancillary behavior, such as voluntarily viewing ads, visiting websites, viewing webpages, visiting a retail outlet, providing referrals, etc., is sometimes rewarded in the hope that the ancillary behavior will lead to a target behavior such as the purchase of a good or service. Unfortunately, such reward systems frequently encounter manipulation and gaming wherein users disingenuously perform the ancillary behavior to acquire the reward without there being any real possibility for the targeted behavior. Such disingenuous ancillary behavior reduces the effectiveness of such reward systems for achieving the targeted behavior.

### BRIEF DESCRIPTION OF THE DRAWINGS

FIG. 1 is a schematic illustration of an example reward system.

FIG. 2 is a flow diagram of an example method that may be carried out by the reward system of FIG. 1.

FIG. 3 is a schematic illustration of an example reward system.

FIG. 4 is a flow diagram of an example method that may be carried out by the reward system of FIG. 3.

FIG. 5 is a schematic illustration of user ancillary behavior data.

FIG. 6 is a schematic illustration of an example reward system.

FIG. 7 is a flow diagram of an example method that may be carried out by the reward system of FIG. 5.

### DETAILED DESCRIPTION OF THE EXAMPLE EMBODIMENTS

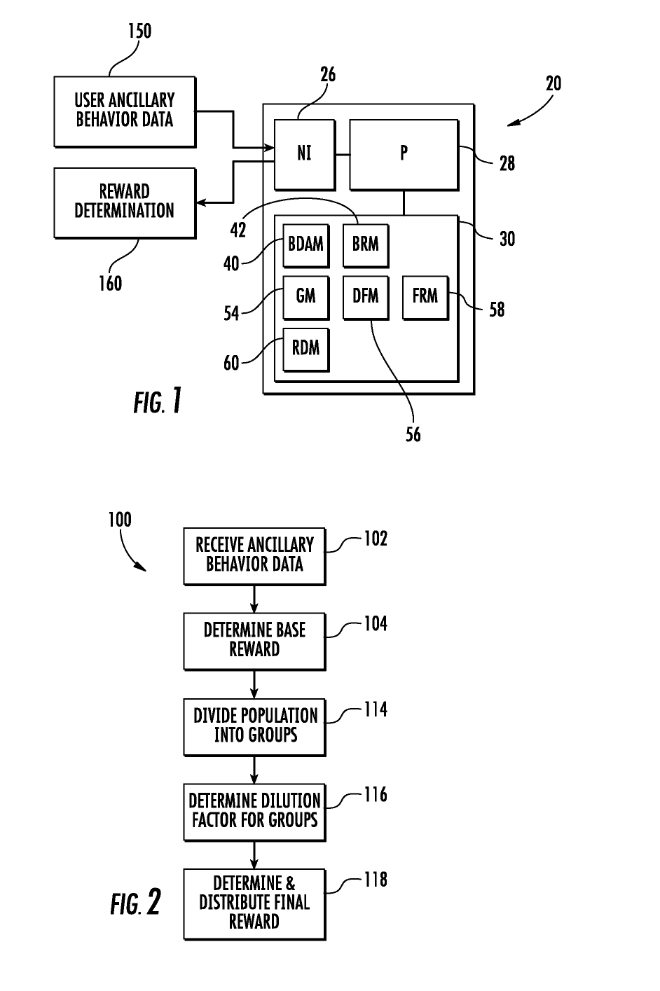

FIG. 1 schematically illustrates an example reward system 20. As will be described hereafter, reward system 20 provides enhanced effectiveness for achieving a targeted behavior by discouraging disingenuous ancillary behavior. As will be described hereafter, reward system 20 discourages disingenuous ancillary behavior by grouping users of the reward system and diluting rewards on a group basis.

Reward system 20 comprises a computing device or system, such as a server or system of servers, that assigns rewards based on received user ancillary behavior data in order to promote targeted behavior(s). Reward system 20 comprises network interface 26, one or more processors 28, and a memory 30. Network interface 26 comprises an electronic or optical interface by which reward system 20 communicates to other computing devices or sources of data through a local area network and/or a wide-area network, such as the Internet. In one implementation, reward system 20 is located at an entity that directly benefits from the targeted behavior. In another implementation, reward system 20 may be subscribed to by multiple remote and different entities that utilize system 20 to increase the effectiveness of their reward programs.

One or more processors 28 comprise one or more processing units configured to carry out instructions contained in memory 30. In general, following instructions contained in memory 30, the one or more processors 28 group users of the reward system and dilute rewards on a group basis. For purposes of this application, the term “processing unit” shall mean a presently developed or future developed processing unit that executes sequences of instructions contained in a memory. Execution of the sequences of instructions causes the one or more processing units to perform steps such as generating control signals. The instructions may be loaded in a random access memory (RAM) for execution by the one or more processing units from a read only memory (ROM), a mass storage device, or some other persistent storage. In other embodiments, hardwired circuitry may be used in place of or in combination with software instructions to implement the functions described. For example, the functionality of system 20 may be implemented entirely or in part by one or more application-specific integrated circuits (ASICs). Unless otherwise specifically noted, the reward system 20 is not limited to any specific combination of hardware circuitry and software, nor to any particular source for the instructions executed by the one or more processing units.

Memory 30 comprises a non-transient computer-readable medium or other persistent storage device, volatile memory such as DRAM, or some combination of these; for example a hard disk combined with RAM. Memory 30 contains instructions for directing the carrying out of functions and analysis by one or more processors 28. In some implementations, memory 30 further stores data for use by the one or more processors 28. Memory 30 stores various software or code modules that direct processor 28 to carry out various interrelated actions. In the example illustrated, memory 30 comprises behavior data acquisition module 40, base reward module 42, grouping module 54, dilution factor module 56, final reward module 58 and reward distribution module 60. Modules 40, 42, 54, 56, 58, and 60 cooperate to direct processor 28 to carry out the method 100 set forth by the flow diagram of FIG. 2.

As indicated by step 102, behavior data acquisition module 40 receives ancillary behavior data for each user belonging to a population of users. Ancillary behavior data for a given user comprises data regarding the specific ancillary behavior that triggered the determination of a reward (triggering ancillary behavior) and possibly additional disingenuous reward-motivated ancillary behavior that may indicate disingenuous motives, wherein the disingenuous ancillary behavior may be counted against the determination of a reward. Examples of triggering ancillary behavior that may trigger a reward or count towards a reward include, but are not limited to, voluntarily viewing an ad, visiting a website, viewing a web page, visiting a retail outlet, providing a referral, and agreeing to a temporary subscription. Examples of disingenuous ancillary behavior that may count against the determination of a reward include already owning a targeted product, having recently received a similar award, and having reached an annual reward cap.

A reward program may specify one or more conditions that must be satisfied for the ancillary behavior to trigger a reward or count towards a reward. For example, in one implementation, a reward program will not reward all visits to a website, but only visits to a website during particular hours of the day, visits during a particular promotional period, visits from a particular link, or particular actions at a website such as completing a profile or providing a referral. Each of the aforementioned ancillary behaviors may be rewarded with the hope that such ancillary behaviors will lead to a targeted behavior such as the purchase, rental, lease, or other more complete acquisition of a product or service. Because each of these ancillary behaviors does not automatically result in the targeted behavior, reward systems that reward these ancillary behaviors are subject to disingenuous reward-motivated ancillary behavior.

By way of example, one target behavior is the purchase of products offered for sale on a webpage or website. To encourage this target behavior, a reward program is established where users are rewarded for an ancillary behavior, such as voluntarily watching an ad for one of the products or signing up for a mailing list. With such a reward program, the hope is that by watching informative ads, the greater the likelihood is that the person will purchase products offered for sale on the webpage or website.

To increase effectiveness, the reward may only be offered to users whose behavior elsewhere indicates that they may need or want the products offered for sale. For example, a site selling baby cribs may wish to offer the reward only to people who have recently had or are expecting a baby. The triggering ancillary behavior thus not only includes the voluntarily watching of an ad, but various behaviors that indicate or may be expected to indicate that the user recently had or is expecting a baby. Disingenuous reward-motivated ancillary behavior occurs when the user clicks on the ad(s) or performs behavior that would normally indicate that she recently had or was expecting a baby for the disingenuous purpose of earning the reward, rather than true interest in the products marketed on the website or information regarding the products market on the website.

In one implementation, behavior data acquisition module 40 obtains ancillary behavior data in a pull fashion, by requesting and retrieving ancillary behavior data 150 from one or more ancillary behavior data sources. For example, where ancillary behavior relates to a user interaction (e.g., their clicking on an ad) with a webpage or website, behavior data acquisition module 40 may request and retrieve (pull) ancillary behavior data 150 from one or more servers that collect or gather information regarding such clicks. In another implementation, behavior data acquisition module 40 obtains or requires ancillary behavior data by receiving the transmission of ancillary behavior data initiated by the ancillary behavior data sources themselves.

As indicated by step 104 of method 100 shown in FIG. 2, base reward module 42 (shown in FIG. 1) determines an undiluted reward for each user belonging to the population of users. The undiluted reward value is a base reward that is subsequently diluted by system 20. For purposes of this disclosure, a “reward” is any remuneration or benefit, including but not limited to: coupons, account credits, cash, vouchers, free or discounted products, free or discounted services, purchasing, notification, access or other priority rights or exclusive privileges. The determination of the undiluted reward may be based on triggering ancillary behavior data received in step 102. The base reward or undiluted reward may be determined for each user independently. In one implementation, the undiluted reward may be the amount of money that would have been paid to each user were there no dilution. In some implementations, the base undiluted reward is a sum of the ad pay rates that the user clicked on during a particular billing period.

In some implementations, base reward module 42 determines the undiluted reward for each user by retrieving, receiving, or otherwise obtaining the undiluted base reward for each user from an outside entity, rather than directly calculating the base reward using the triggering ancillary behavior data. For example, the outside entity, such as an entity directing or running the reward program supplies reward system 20 with the values for the undiluted base rewards, wherein reward system 20 divides the users into groups and then determines and applies dilution factors to the received values for the undiluted base rewards. In such a case, the ancillary behavior data received in step 102 may omit triggering ancillary behavior data 152.

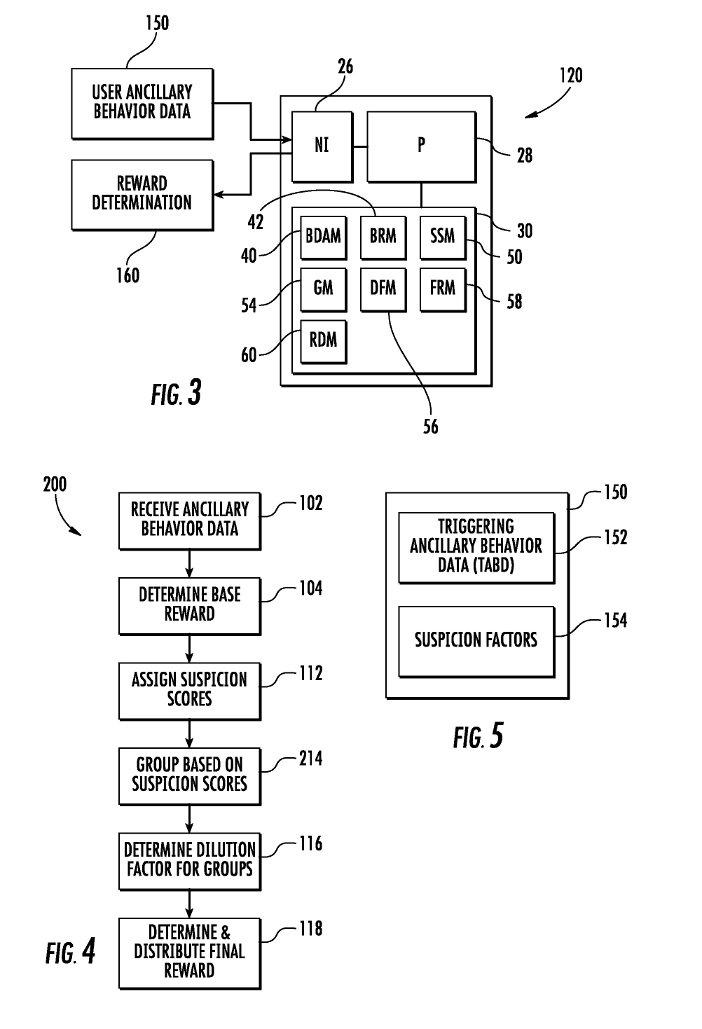

As indicated in step 114 of FIG. 2, grouping module 54 of system 20 (shown in FIG. 1) divides the population of users into groups. In one implementation, grouping module 54 may divide the population of users into groups based upon the interrelationships or relationship data between different users. In another implementation, grouping module 54 may divide the population of users into groups based upon various suspicion factors, which are factors that indicate disingenuous ancillary behavior, as described hereafter with respect to FIGS. 3-5. In another implementation, grouping module 54 may divide the population of users into groups using both relationship data and suspicion factors. In still other implementations, grouping module 54 may divide the population of users into groups using other criteria.

As indicated by step 116 in FIG. 2, dilution factor module 56 of system 20 (shown in FIG. 1) determines a dilution factor F for each group. The dilution factor for an individual group is a value by which the undiluted reward for each user in that individual group will be diluted. In one implementation, the dilution factor is an amount that is subtracted from the undiluted reward of each user in a group. In another implementation, the dilution factor may be a value between zero and one which is multiplied by an undiluted reward to determine either a diluted reward amount or an amount that is to be subtracted from the corresponding base reward. The dilution factor for each group may be determined in a variety of different fashions. For example, the dilution factor for each group may be based, at least in part, upon the disingenuous reward-motivated ancillary behavior of the individual users in that particular group. In other implementations, the dilution factor for each group may be based upon an aggregation of disingenuous reward-motivated ancillary behavior collectively exhibited by all the users in the group, determined on a group-wide basis. The dilution factor may be based upon an extent to which the target behavior is attained such as the average or median dollar amount spent by the users of the group. For example, the dilution factor may be based upon the conversion rate of triggering ancillary behavior to actual target behavior such as the conversion rate of clicks to actual purchases for the group as a whole.

In one implementation, dilution factor module 56 further normalizes such dilution factors. For example, in some implementations, the dilution factors of the different groups are linearly scaled such that the best group has a dilution factor F of 0% (no dilution) and the worst group has a dilution factor F of 80% (e.g., the users of the worst group receiving 20% of their base reward values). In other implementations, the groups are ranked and given equidistant dilution factor scores covering a range, such as a range between 0% and 80%. In yet other implementations, the dilution factor F is set at 0% or 100% depending on a threshold on the input score. For example, groups that behave badly enough beyond a predetermined threshold, may receive no reward despite the upper end of the normalization range for F being at 80%.

As indicated by step 118 of FIG. 2, final reward module 58 assigns a final reward value for each user of the population of users and reward distribution module 60 communicates the reward determinations 160 for each user via network interface 26. For each user, final reward module 58 retrieves their undiluted reward value determined by base reward module 42 and retrieves the dilution factor F for the group that they belong to determined by dilution factor module 56. Reward module 58 determines their final reward value based upon their undiluted reward value and the dilution factor of their group.

Reward distribution module 60 may communicate the assigned final reward values to the particular users. In one implementation, reward distribution module 60 may transmit the reward determinations 160 directly to the users via a wide area network. For example, reward distribution module 60 retrieves from memory 30 or generates a coupon, certificate, or the like which is attached to or sent as part of an e-mail to each of the users. In another implementation, reward distribution module 60 communicates through an e-mail, telephone message, or regular mail to send a code, password, or other authorization to each user that allows the users to visit a website or webpage to gain access to a printable or downloadable coupon, certificate, or the like redeemable for the reward. In yet other implementations, reward distribution module 60 transmits the reward determination 160 to a server or other computing center of the entity directing the reward program, wherein the directing entity may make their award available to the user. For example, the directing entity may support a website for printing or downloading the coupon or certificate or the directing entity may have its own website on which the user may gain access to the coupon or certificate. The directing entity alternatively simply notifies the user of the reward and credit the reward to the user's account or credit line with the directing entity.

By carrying out method 100, reward system 20 discourages disingenuous ancillary behavior to improve the effectiveness of reward system 20 at focusing rewards towards true ancillary behavior that leads to the target behavior. Because reward system 20 divides, segments, clusters, or groups the population of users into groups and assigns dilution factors to the users depending upon the group to which that user belongs, system 20 imposes soft penalties in the form of reward dilutions to individual groups of users. This decreases incentives for disingenuous users to continue to game the reward program, while also reducing the likelihood that innocent users are unfairly punished with reward dilution or even frozen or blocked from further participation in the reward program as a result of being a false positive of a heuristic algorithm designed to make a hard, binary decision about which users to exclude from the rewards program for ill behavior.

FIG. 3 schematically illustrates reward system 120, an example implementation of reward system 20. Similar to reward system 20, reward system 120 provides enhanced effectiveness for achieving a targeted behavior by discouraging disingenuous ancillary behavior. Reward system 20 discourages disingenuous ancillary behavior by grouping users based upon individually assigned suspicion scores and diluting rewards on a group basis.

Reward system 120 comprises a computing device or system, such as a server or system of servers, that assigns rewards based on received user ancillary behavior data in order to promote targeted behavior(s). Reward system 120 is similar to reward system 20 except that memory 30 of reward system 120 additionally comprises suspicion score module 50 and grouping module 54 groups users based upon scores determined by suspicion score module 50. Those remaining components of reward system 120 that correspond to components of reward system 20 are numbered similarly. Modules 40, 42, 50, 54, 56, 58, and 60 of reward system 120 cooperate to direct processor 28 to carry out the method 200 set forth by the flow diagram of FIG. 4. Method 200 is similar to method 100 described above except the method 200 comprises step 214 in lieu of step 114 and further comprises step 112. Those remaining steps of method 200 that correspond to steps of method 100 are numbered similarly.

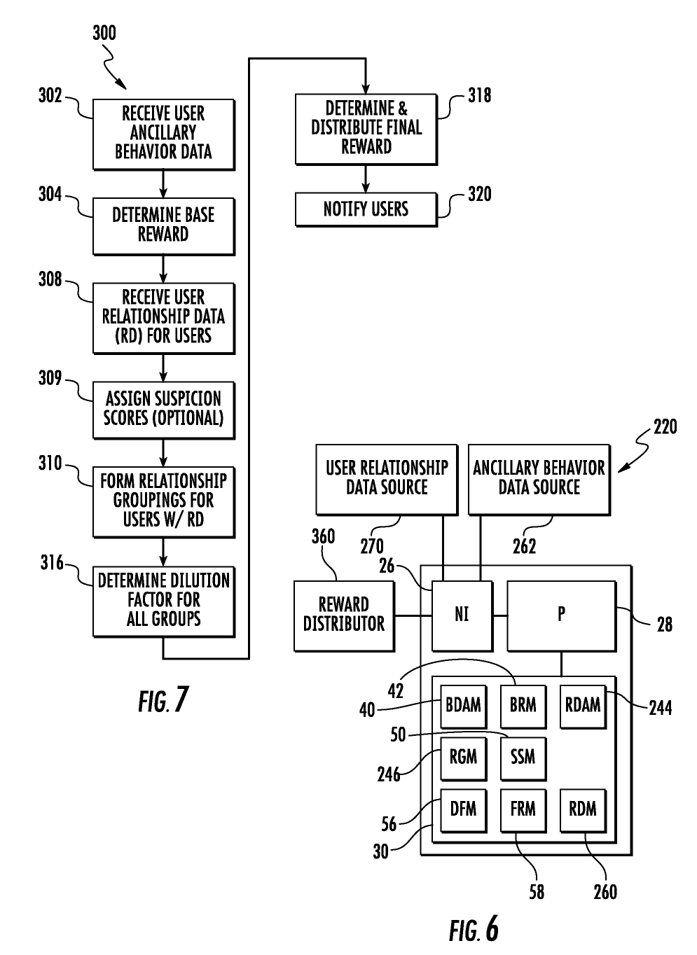

As indicated by step 102, behavior data acquisition module 40 receives ancillary behavior data for each user belonging to a population of users. As schematically shown by FIG. 5, such ancillary behavior data 150 for a given user may comprise triggering ancillary behavior data (TABD) 152 and suspicion factors 154. The TABD 152 comprises data regarding the specific ancillary behavior that triggered the determination of a reward and possibly additional ancillary behavior that is counted towards or against the determination of a reward. Examples of ancillary behavior that may trigger a reward or count towards a reward include, but are not limited to, voluntarily viewing an ad, visiting a website, viewing a web page, visiting a retail outlet, providing a referral, and agreeing to a temporary subscription.

The suspicion factors 154 of ancillary data 152 may comprise those characteristics associated with the triggering ancillary behavior or the user who engaged in the triggering ancillary behavior that are not part of the triggering ancillary behavior. In other words, the suspicion factors 154 may not be part of a condition for the ancillary behavior to count towards a reward. Reward system 20 may utilize the suspicion factors 154 to identify suspicious behavior that merits reward dilution. Such suspicion factors 154 relate to the triggering ancillary behavior itself or relate to other actions of the user, proximate in time to the time at which the user engaged in the triggering ancillary behavior. Examples of such suspicion factors 154 include, but are not limited to, the time(s) of day that the triggering ancillary behavior occurred, the rate at which the triggering ancillary behavior occurred, the duration or length of time during which multiple triggering ancillary behavior occurred, the spacing between different triggering ancillary behaviors, the entropy or diversity of multiple triggering ancillary behaviors, the rate at which the triggering ancillary behaviors resulted in the final target behavior, or an extent to which the target behavior occurred. Note that the received ancillary behavior data may not be broken out already into TABD 152 and suspicion factors 154. Behavior data acquisition module 40 may have to process received ancillary behavior data to extract these components.

By way of example, one target behavior is the purchase of products offered for sale on a webpage or website. To encourage this target behavior, a reward program is established where users are rewarded for an ancillary behavior, such as voluntarily watching an ad for one of the products or signing up for a mailing list. With such a reward program, the hope is that by watching informative ads, the greater the likelihood is that the person will purchase products offered for sale on the webpage or website.

To increase effectiveness, the reward may only be offered to users whose behavior elsewhere indicates that they may need or want the products offered for sale. For example, a site selling baby cribs may wish to offer the reward only to people who have recently had or are expecting a baby. The triggering ancillary behavior thus not only includes the voluntarily watching of an ad, but various behaviors that indicate or may be expected to indicate that the user recently had or is expecting a baby. Disingenuous ancillary behavior occurs when the user clicks on the ad(s) or performs behavior that would normally indicate that she recently had or was expecting a baby for the disingenuous purpose of earning the reward, rather than true interest in the products marketed on the website or information regarding the products market on the website.

Suspicion factors 154 may include behaviors indicating the user is interested in too many products at once or contradictory behaviors (e.g., just signed up for a wedding registry and a dating site or belongs to an ardent environmentalist mailing list and requested information on a Hummer). These kinds of behaviors may indicate that the user is attempting to qualify for many different rewards by pretending to be interested in everything. Other suspicion factors 154 may indicate that the “user” is actually a bot or computer program designed to collect rewards. These factors may include an excessive count or rate at which a user has requested a page at the website, abnormally high correlation between the presentation of an ad or offer and clicking on the ad or offer (click-through rate), a very short estimated duration or length of time during which the user stayed on the website or webpage, extreme session lengths (contiguous duration of time during which the user is at the website), unusually regular spacing between successive clicks on the webpage link (inter-arrival time), abnormal time of day for such clicks on the webpage or website link, an entropy or diversity of the web pages links clicked upon by the user that indicates no natural preference among products (such as a robot clicking on all links), extremely low proportion of clicks on the website or webpage that result in the purchase of a product (product purchase conversion rate) and/or an abnormally low dollar value of the product purchased following clicks of the link to visit the webpage or website (product purchase values). Such suspicion factors further comprise other marketing characteristics associated with the user engaging in the triggering ancillary behavior such as the user's geographic location, age, gender, income level, profession, family status, and the like. In one implementation, such marketing characteristics associated with the user are used as a factor in identifying other suspicious ancillary behavior or in weighting a severity of the other suspicious activity or factor. In some implementations, such marketing characteristics may independently indicate suspicious activity such as a person with a low income level repeatedly visiting a website advertising high priced luxury products beyond the realistic purchasing capability of the person.

As indicated by step 104 of method 200 shown in FIG. 4, base reward module 42 (shown in FIG. 3) determines an undiluted reward for each user belonging to the population of users. The undiluted reward value is a base reward that is subsequently diluted by system 120. The determination of the undiluted reward may be based on triggering ancillary behavior data 152 received in step 102. The determination of the base reward may in some implementations not be based upon the suspicion factors of the triggering ancillary behavior. The base reward or undiluted reward may be determined for each user independently. In one implementation, the undiluted reward may be the amount of money that would have been paid to each user where there no dilution. In some implementations, the base undiluted reward is a sum of the ad pay rates that the user clicked on during a particular billing period.

In some implementations, base reward module 42 determines the undiluted reward for each user by retrieving, receiving, or otherwise obtaining the undiluted base reward for each user from an outside entity, rather than directly calculating the base reward using the triggering ancillary behavior data 152. For example, the outside entity, such as an entity directing or running the reward program supplies reward system 20 with the values for the undiluted base rewards, wherein reward system 20, using the suspicion factors 154 (that are also received from the outside entity or acquired by reward system 20 in another fashion) divides the users into groups and then determines and applies dilution factors to the received values for the undiluted base rewards. In such a case, the ancillary behavior data received in step 102 may omit triggering ancillary behavior data 152.

As indicated by step 112 of FIG. 4, suspicion score module 50 determines and assigns a suspicion score to each of the users. It determines the suspicion scores based upon the suspicion factors 154 of the ancillary behavior data 150 for each user. Suspicion scores may be determined in a variety of different fashions. For example, if the associated characteristic 154 for a particular user indicates a click-through rate for a webpage or website that exceeds a predefined threshold, suspicion score module 50 may assign the particular user a high suspicion score. Robots and automated programs sometimes have a very high and unnatural click-through rate. In some implementations, the measurement itself (such as click-through rate) is mathematically transformed in a linear mapping or non-linear mapping to an output range for a suspicion score.

In some circumstances there may be insufficient data to determine a reliable suspicion score for certain users. In this circumstance these users may be assigned a neutral score that may be represented by a neutral value. Alternatively, if there is insufficient data to calculate a suspicion score, no value may be explicitly assigned and the absence of a score may be understood to be an implicitly assigned neutral score.

If the suspicion factors 154 for a particular user indicate that that user has been on the webpage or online for a prolonged period of time or during particular odd hours of the day, suspicion score module 50 may assign that user a high suspicion score. The high suspicion score is based on the presumption that an account that is active for an extended period of time (e.g., 24 hours a day) may suggest a robot/automated program rather than a person who needs to sleep occasionally.

Similarly, the suspicion factors 154 received in step 102 may indicate an odd inter-arrival time of clicks, such as abnormally periodic or uniform spacing between clicks, suggesting an automated program, a robot. In such circumstances, suspicion score module 50 may assign a high suspicion score if such inter-arrival times for the clicks lack sufficient variation.

If the suspicion factors 154 for a particular user indicate that that particular user has engaged in an abnormally diverse dispersion or entropy of triggering ancillary behaviors, suspicion score module 50 may assign a high suspicion score to that user. For example, with regard to a reward program that rewards visits to a webpage ad for a particular type of product, suspicion factors 154 indicating that the same user visited, within a predefined time period, other webpage ads for multiple disparate products suggest that the user's visit to the webpage associated with the reward program was disingenuous as it may be unlikely that the user would be interested in all of the different ad categories during a short period of time.

If the suspicion factors 154 for a particular user indicate a low conversion rate of triggering ancillary behavior to actual targeted behavior, suspicion score module 50 may assign a high suspicion score to that user. For example, with regard to a program that rewards visits to a website or webpage, suspicion score module 50 may assign a high suspicion score to a user who has visited the website a predefined number of times without purchasing any product on the website or without purchasing a minimum number or dollar value of products. In some implementations, suspicion score module 50 assigns a suspicion score to a user using combinations of the above described suspicious indicia or other suspicious indicia identified from the suspicion factors 154 received in step 102.

As indicated in step 214 of FIG. 4, grouping module 54 of system 20 (shown in FIG. 1) divides the population of users into groups. Grouping module 54 of system 120 divides the population of users into groups based upon suspicion scores. System 220 described later specifically describes a case wherein the grouping module divides the population of users into groups based on both suspicion scores and relationship data.

Grouping module 54 in system 120 groups the population of users based upon the suspicion scores of the users determined in step 112. In one implementation, grouping module 54 ranks users based upon the suspicion scores. The rankings assigned to the individual users are then used to place the users into different groups. In one implementation, suspicion score grouping module 54 may carry out a partitioning algorithm that divides users based on their suspicion score rankings into a predetermined number of groups. According to one example, the users are divided into N groups, each group having an almost equal number of users. According to another example, the users are divided into N groups of approximately equal weight, wherein the weight of a group is determined by the suspicion scores, product purchases, or suspicion factors 154 of its members. In some implementations, rather than using a fixed N number of groups, the number of groups and the assignment of users into such groups may be based upon a threshold for a maximum cumulative weight per group. In yet other implementations, unsupervised clustering algorithms, such as K-means clustering, are utilized to group the users into individual groups based upon suspicion scores as well as possibly other attributes of the users. In other implementations, other algorithms, heuristics, methods or techniques are utilized to group the users based upon suspicion scores. In some implementations, to avoid having identical groupings from month to month or reward payment period to reward payment period, limited random perturbation, disruption, or redistributions of the rankings or clustering may be utilized.

In yet another implementation, grouping module 54 may divide the population of users into groups using both relationship data and suspicion scores. An example of this implementation is described hereafter with respect to FIGS. 6 and 7. In yet other implementations, system 120 may divide the population of users into groups in other fashions or based upon other data.

As indicated by step 116 in FIG. 4, dilution factor module 56 (shown in FIG. 3) determines a dilution factor for each of the dilution groups. The determination of a dilution factor for each of the groups may be carried out in the fashion described above with respect to step 116 of method 100 (shown in FIG. 2). As indicated by step 118 in FIG. 4, final reward module 58 assigns rewards and communicates the reward determinations to a reward distribution module 60. Step 118 is carried out by one or more processors 28 (via final reward module 58) and by reward distribution module 60 in the fashion described above with respect to step 118 of method 100 (shown in FIG. 2). As indicated by step 118 in FIG. 4, final reward module 58 assigns rewards and communicates the reward determinations to a reward distribution module 60. Step 118 is carried out by one or more processors 28 (via final reward module 58) and by reward distribution module 60 in the fashion described above with respect to step 118 of method 100 (shown in FIG. 2).

By carrying out method 200, reward system 120 discourages disingenuous ancillary behavior to improve the effectiveness of reward system 120 at focusing rewards towards true ancillary behavior that leads to the target behavior. Because reward system 120 divides, segments, clusters, or groups the population of users into groups and assigns dilution factors to the users depending upon the group to which the user belongs, system 120 imposes soft penalties in the form of reward dilutions to individual groups of users. This decreases incentives for disingenuous users to continue to game the reward program, while also reducing the likelihood that innocent users are unfairly punished with reward dilution or even frozen or blocked from further participation in the reward program as a result of being a false positive of a heuristic algorithm designed to make a hard, binary decision about which users to exclude from the rewards program for ill behavior.

FIG. 6 schematically illustrates reward system 220, an example implementation similar to reward system 20. Reward system 220 groups a population of users based upon relationship data and depending on the implementation also suspicion scores. Reward system 220 is similar to reward system 20 except that reward system 220 has a memory 30 additionally comprising relationship data acquisition module 244 while alternatively comprising relationship grouping module 246 in lieu of grouping module 54 and alternatively comprising reward distribution module 260 in lieu of reward distribution module 60. Suspicion score module 50 may only be present in implementations that use suspicion scores. The remaining components of reward system 220 that correspond to reward system 20 are numbered similarly.

Modules 40, 42, 244, 246, optional 50, 56, 58 and 260 cooperate to direct one or more processors 28 to carry out the method 300 set forth by the flow diagram of FIG. 7. As indicated by steps 302 and 304 of method 300 in FIG. 7, behavior data acquisition module 40 and base reward module 42 direct one or more processing units 28 to receive user ancillary behavior data 150 from one or more ancillary behavior data sources 262 and to determine (e.g., calculate, receive, or obtain) the undiluted base reward for each user, respectively, similar to steps 102 and 104 of method 100.

As indicated by step 308 in FIG. 7, relationship data acquisition module 244 (shown in FIG. 6) receives user relationship data (RD) for users belonging to the population of users. User relationship data means data tending to indicate a social or personal relationship of some sort between two or more users. As shown by FIG. 6, relationship data acquisition module 244 may consult one or more user relationship data sources 270 across a wide area network through network interface 26. Examples of user relationship data sources include, but are not limited to, professional organization directories, business directories, organization membership databases or directories, professional networks (e.g., LinkedIn), social networks (e.g., Facebook), and the like. For example, user relationship data from a social network may indicate that two or more users have a direct personal relationship to one another by the fact that such users are marked as “friends.” In one implementation, relationship data acquisition module 244 searches through various online ancillary behavior data sources 262 (using network interface 26) to acquire user relationship data for the users. In some implementations, reward system 220 requests the users to provide identification of other users or contacts with which the user has a relationship. For some users, user relationship data may not be available.

As indicated by optional step 309 in FIG. 7, suspicion score module 50 may be present and may assign suspicion scores for the users. Step 309 when present is substantially similar to step 112 described above. In one implementation suspicion score module 50 directs one or more processors 28 to determine and assign suspicion scores for each of the users.

As indicated by step 310 in FIG. 7, relationship grouping module 246 (shown in FIG. 6) divides users into dilution groups based upon the user relationship data acquired in step 308. In some implementations, this is done without using suspicion scores. Relationship grouping module 246 attempts to assign users sharing a relationship or belonging to the same social group to the same dilution group. The greater the strength of a relationship (e.g., marriage is stronger than dating is stronger than dated once), the more likely relationship grouping module 246 may assign a pair of users to the same dilution group. In one implementation, users are assigned to independent, non-overlapping groups based upon the user relationship data. Users assigned to the same group will have their base rewards diluted using the same dilution factor. In some implementations, where dilution groups are based on social groups and where the user relationship data may indicate different groups to which a user may be assigned, relationship grouping module 246 directs one or more processors 28 to assign the particular user to a particular dilution group based upon a strength of an affiliation of the user to the associated social group given the characteristic of a user relationship data. For example, in one implementation, priority may be given to a social interrelationship of the user over a professional or organizational relationship of the user. In such a circumstance, the assignment of the user to a particular group may be based upon the relationship data pertaining to the social interrelationship over the relationship data pertaining to a professional or organizational relationship.

In alternative implementations, relationship grouping module 246 may divide users into groups based on both user relationship data from step 308 and suspicion scores from step 309. In some implementations, some dilution groups of users are determined using the relationship data alone, and then the remaining dilution groups are formed using the suspicion scores alone. For example, first, non-overlapping sub-groups of inter-related users are extracted from the user relationship data using known methods (e.g., data mining clustering methods or methods that extract n-cliques, k-plexes, or k-cores from social network graphs), and, second, the remaining users (those lacking sufficient relationship data and those who were not selected for a dilution group by the sub-group extraction algorithm) are clustered solely by their suspicion scores, using a method such as those referred to previously.

In other implementations, all the users are divided into groups using both the relationship data and the suspicion score together. This can be accomplished by using a clustering algorithm—of which there are many in the field of data mining—with a distance function that involves both relationship data as well as the suspicion scores. For example, a K-means or hierarchical divisive or agglomerative clustering algorithm can be applied to the dataset using a distance function that measures the distance between two users based on (a) their percentage of common connections in the user relationship data and (b) the difference between their suspicion scores. The distance is a weighted average of (a) and (b) using a pre-determined weight constant, e.g., 75% based on (a) and 25% based on (b). In some implementations, the clustering algorithm may be chosen or designed to produce groups of approximately equal size. In other implementations, other algorithms, heuristics, methods, or techniques are utilized to group the users based upon user relationship data and/or suspicion scores. In some implementations, to avoid having identical groupings from month to month or reward payment period to reward payment period, limited random perturbation, disruption, or redistributions of any rankings or clustering may be utilized. In such implementations, the division into groups is based upon randomness as well as upon suspicion scores and/or user relationship data.

As indicated by step 316 in FIG. 7, dilution factor module 56 (shown in FIG. 6) determines a dilution factor for each of the dilution groups. The determination of a dilution factor for each of the groups may be carried out in the fashion described above with respect to step 116 of method 100 (shown in FIG. 2).

As indicated by step 318 in FIG. 7, final reward module 58 assigns rewards and communicates the reward determinations to a reward distribution module 260. Step 318 is carried out by one or more processors 28 (via final reward module 58) and by reward distribution module 260 in the fashion described above with respect to step 118 of method 100 (shown in FIG. 2).

As indicated by step 320, reward distribution module 260 further notifies users with information. In some implementations, this information may pertain to the dilution factor that was applied to the group they are in. In one implementation, reward distribution module 260 may provide each user of a dilution group with information indicating the dilution factor that was applied for that group as well as the basis for the dilution factor. In one implementation, as part of the described dilution factor basis, the reward distribution module 260 additionally informs the user of the identity of other users in the same group. In one implementation, the other users comprise those whose behavior caused a worse dilution factor to be applied to that group. That is, reward distribution module 260 may communicate to a user the identities of at least one user that belongs to the same group of the groups as the user and whose behavior caused a worse dilution factor for the users group. In some implementations, these users may be those with high suspicion scores and the reward distribution module 260 may further inform the user of the suspicion scores or suspicion factors of one or more of the other members of the same group.

As a result of the communication from the reward distribution module 260, a user is able to identify those other users of the same group that may have behaved in such a way as to have resulted in a higher dilution factor being applied to the user's reward. Because the identities of the these members that hurt the dilution factor the worst are made known to the whole group as well as an explicit indication of the group dilution factor, reward system 220 facilitates self-interest-based peer pressure to encourage users in the group to discontinue or reduce disingenuous triggering ancillary behavior.

In alternative implementations, users of the population of users are assigned to one or more dilution groups instead of just one dilution group each. In an example, relationship grouping module 246 assigns each user to one of a first set of dilution groups based on their suspicion score and to one of a different second set of dilution groups based on their user relationship data. In such an implementation, an individual user may belong to a first dilution group based upon the user suspicion score and a second dilution group based upon relationships. In another example, each important social group may be mapped to a dilution group, with each user being assigned to the dilution groups corresponding to the social groups they belong to. Alternatively, users may only be assigned to their top N social groups.

In such implementations where users belong to multiple dilution groups, each user will “share” the dilution factor assigned to each of the groups they belong to. For example, a user may be assigned to a first group having a dilution factor of 10% and a second group having a dilution factor of 30%. In one implementation, final reward module 58 utilizes both dilution factors when determining the final reward for the particular user. For example, final reward module 58 may apply an average of the dilution factors for each of the groups to which the user has been assigned (20% in the example).

In yet other implementations, the final reward module 58 randomly selects one of the dilution groups to which the user belongs for determining which dilution factor to apply to the user. In yet other implementations, the final reward module 58 selects one or more of the dilution groups to which the user belongs based upon other criteria. For example, final reward module 58 may set a policy or rule (applied by one or more processors 28) that the lowest of the dilution factors of the groups to which the user belongs is to be applied, that the highest of the dilution factors of the groups to which the user belongs is to be applied, or that a median or average of the dilution factors of the groups which a user belongs is to be applied.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method for converting inputted user behavior data into outputted rewards, the method comprising:
receiving ancillary behavior data for each user of a population of users;
determining an undiluted reward for a user belonging to the population of users based upon the ancillary behavior data;
dividing the population of users into groups;
determining a dilution factor for each of the groups; and
assigning a reward to the user based upon the undiluted reward of the user and the dilution factor of the group to which the user belongs.

2. The method of claim 1, wherein dividing the population of users into groups is based in part upon one of: suspicion scores or user relationship data.

3. The method of claim 2, further comprising:
assigning a suspicion score to each user of the population of users; and
dividing the population of users into groups based upon the suspicion scores.

4. The method of claim 2, further comprising:
receiving user relationship data for the population of users; and
dividing the population of users into groups based upon the user relationship data.

5. The method of claim 3, wherein assigning of the suspicion scores is based upon at least one suspicion score criteria selected from a group of suspicion score criteria consisting of: click-through rate, account session length, inter-arrival time of clicks, time of day, category entropy, product purchase conversion rate, and product purchase values.

6. The method of claim 1 further comprising notifying the user with information pertaining to the dilution factor of the group that user belongs to.

7. The method of claim 3, wherein the dividing of the population of users into groups based upon the suspicion scores comprises:
ranking the population of users based on the suspicion score of each user; and
dividing the users into the groups based upon the rank of each user.

8. The method of claim 3, wherein the users are assigned to the groups based upon the suspicion scores by dividing the population of users into a number of groups having approximately equal weight, wherein a group's weight is determined by its users' suspicion scores.

9. The method of claim 1 further comprising communicating to the user the identities of at least one user that belongs to the same group of the groups as the user and whose behavior caused a worse dilution factor for the user's group.

10. The method of claim 1, wherein the dilution factor for each of the groups is based upon one of: the conversion rate to purchase for that group and a spending characteristic of that group.

11. The method of claim 1, wherein the ancillary behavior is selected from a group of behaviors consisting of: watching an ad, visiting a website, viewing a web page, visiting a retail outlet, providing a referral, and agreeing to a temporary subscription.

12. The method of claim 1, wherein dividing the population of users into groups is in part based upon randomization.

13. An apparatus comprising:
a non-transient computer-readable medium containing programming to direct a processing unit to:
determine an undiluted reward for a user of the population of users based upon ancillary behavior data;
divide the population of users into groups;
determine a dilution factor for each of the groups; and
assign a reward to the user based upon the undiluted reward and the dilution factor for the group to which the user belongs.

14. A computerized reward system comprising:
a network interface;
a processing unit in communication with the network interface;
a memory containing instructions for direction of the processing unit, the instructions comprising:
a user data acquisition module to direct the processing unit to acquire user behavior data using the network interface;
a grouping module to direct the processing unit to group users;
a dilution factor module to direct the processing unit to assign a reward dilution factor to each group;
a base reward module to direct the processing unit to determine a base reward for a user based on the acquired user behavior data;
a reward module to direct the processing unit to determine a final reward for the user based upon the base reward for the user and the group to which the user has been assigned; and
a reward distribution module to direct the processing unit to transmit the determined final reward for the user using the network interface.

15. The computerized reward system of claim 14 wherein the grouping module divides the population of users into groups based upon one of: suspicion scores or user relationship data.
